(19) United States
(12) Patent Application Publication
(10) Pub. No.: US 2019/0392617 A1
(43) Pub. Date: Dec. 26, 2019

(54) VISUAL WORKFLOW MODEL

(71) Applicant: ServiceNow, Inc., Santa Clara, CA (US)

(72) Inventors: Jared Laetham, Carlsbad, CA (US); Frances Denise Thompson, San Diego, CA (US); Harry Thomas Nelson, San Diego, CA (US); Russell Samuel Sarbora, Kitty Hawk, NC (US); Benjamin Nicklaus Greer, San Diego, CA (US)

(21) Appl. No.: 16/515,799

(22) Filed: Jul. 18, 2019

Related U.S. Application Data
(63) Continuation of application No. 15/594,110, filed on May 12, 2017.
(60) Provisional application No. 62/335,942, filed on May 13, 2016.

(51) Int. Cl. G06T 11/20; G06T 11/60; G06F 3/0484

(52) U.S. Cl. CPC G06T 11/206; G06T 2200/24; G06F 3/04847; G06T 11/60

(57) ABSTRACT

Workflows can be refactored using a visual workflow model, such as within a virtual programming environment. A selection of a group of activities in an existing workflow can be received. The group of activities can be duplicated into a new workflow. Thereafter, the group of activities can be parsed to identify at least one input variable used by the activities of the group and at least one output variable resulting from those activities. The input variables and output variables are then duplicated as inputs and outputs to the new workflow. The previously selected group of activities can be replaced in the existing workflow with an activity based on the new workflow. The input variables and output variables are then mapped to the respective inputs and outputs of that activity.

### TECHNICAL FIELD

The present disclosure relates in general to techniques and devices for creating and editing workflows using a visual workflow model.

### BACKGROUND

A computer-based workflow can represent a type of activity that is controlled, directed, or monitored by a computer system. It may be made up of a plurality of activities that are in some way related to the overall workflow and have defined aspects.

Workflows, and their respective activities, may be defined in a number of ways. In a visual programming-type system, the constituent component activities of workflows may be represented by modules (activities) in a form of blocks that maintain variables and preserve state, presented in a workspace (which can also be referred to as a canvas) with lines (which can also be referred to as a wire) that may link the blocks together (to form transitions between activities). In this way, a flow of activities can be graphically represented.

### SUMMARY

Disclosed herein are aspects of systems and methods for creating and editing workflows using a visual workflow model.

According to an implementation, a system, method, and related computer readable non-volatile medium are provided for creating a workflow, comprising: a memory, a processor configured to execute instructions stored within the memory, a display device upon which graphical images representing a workflow are displayed on a canvas, wherein: the workflow comprises at least three activity blocks that are represented by the graphical images, at least some of the graphical images representing the activity blocks connected by transitions displayed on the canvas between the graphical images, at least two of the activity blocks are selectable by a user interface action to generate a new workflow, and inputs and outputs for the selected activity blocks are automatically generated by the processor executing the instructions.

These and other implementations of the present disclosure are disclosed in the following detailed description, the appended claims, and the accompanying figures.

### BRIEF DESCRIPTION OF THE DRAWINGS

The description herein makes reference to the accompanying drawings wherein like reference numerals refer to like parts throughout the several views.

FIG. 1 is a block diagram of a distributed or cloud computing system.

FIG. 2 is a block diagram of an implementation of an internal configuration of a computing device, such as a computing device of the computing system as shown in FIG. 1.

FIG. 3 is a block diagram of an implementation of a high availability processing system.

FIGS. 4A-4C are parts of a screen shot illustrating an example implementation of a user interface for working with a workflow in a visual programming environment.

FIGS. 5A-E are graphical images of example activity blocks of a workflow according to an implementation.

FIG. 5F is an example screen shot showing relevant variables for a selected workflow.

FIGS. 6A-11 are example screen shots of example implementations of a workflow system.

### DETAILED DESCRIPTION

A graphical user interface may be utilized for the creating and editing of workflows that provides according to various implementations, flexibility of design by permitting element mapping, which can include permitting a mapping of where a value of a variable may be fetched from or placed to. Furthermore, elements for performing looping, iteration, event controls, and re-entrant activities (e.g., waiting for external events before progressing, etc.) can be provided. These elements may have multiple inputs and multiple outputs to provide flexibility in transitions between workflow activities. Event activities can be utilized within the workflow for pausing and resuming execution according to external events. Visual refactoring can also be provided, which can include permitting a sub-portion of a workflow to be formed into a separate workflow that can be reused, which may be achieved by an automated assignment of input and output variables.

According to an implementation of a workflow system, explicit inputs and outputs may be based on an Application Programming Interface (API) for activities and workflows. Subflows can serve to unify the API exposed by workflow activities and workflows so that there may be a single API for passing data and a workflow can be used as a reusable activity. Workflow transitions may occur based on evaluating encoded query conditions against workflow variables, and a workflow event model may be articulated, visible in the canvas and controllable from within the canvas. The variables discussed herein may be an off-row storage mechanism for storing unstructured data that can be dot-walked from a parent record.

### Background Architecture

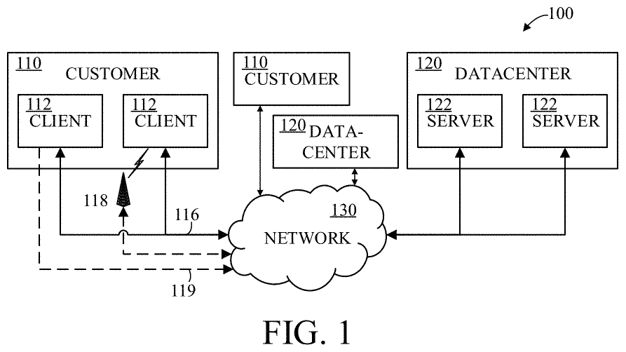

To describe some implementations in greater detail, reference is first made to examples of hardware structures and interconnections usable in implementations of the present disclosure. FIG. 1 is a block diagram of a distributed or cloud computing system 100. Use of the phrase “cloud computing system” herein is a proxy for any form of a distributed computing system, and this phrase is used simply for ease of reference. Cloud computing system 100 can have any number of customers, including customer 110. Each customer 110 may have clients, such as clients 112. Each of clients 112 can be in the form of a computing system including multiple computing devices, or in the form of a single computing device, for example, a mobile phone, a tablet computer, a laptop computer, a notebook computer, a desktop computer, and the like. Customer 110 and clients 112 are examples only, and a cloud computing system may have a different number of customers or clients or may have a different configuration of customers or clients. For example, there may be hundreds or thousands of customers and each customer may have any number of clients.

Cloud computing system 100 can include any number of datacenters, including datacenter 120. Each datacenter 120 may have servers, such as servers 122. Each datacenter 120 may represent a facility in a different geographic location where servers are located. Each of servers 122 can be in the form of a computing system including multiple computing devices, or in the form of a single computing device, for example, a desktop computer, a server computer and the like. The datacenter 120 and servers 122 are examples only, and a cloud computing system may have a different number of datacenters and servers or may have a different configuration of datacenters and servers. For example, there may be tens of datacenters and each datacenter may have hundreds or any number of servers.

Clients 112 and servers 122 may be configured to connect to network 130. The clients for a particular customer may connect to network 130 via a common connection point 116 or different connection points, e.g. a wireless connection point 118 and a wired connection point 119. Any combination of common or different connections points may be present, and any combination of wired and wireless connection points may be present as well. Network 130 can be, for example, the Internet. Network 130 can also be or include a local area network (LAN), wide area network (WAN), virtual private network (VPN), or any other means of transferring data between any of clients 112 and servers 122. Network 130, datacenter 120 and/or blocks not shown may include network hardware such as routers, switches, load balancers and/or other network devices.

Other implementations of the cloud computing system 100 are also possible. For example, devices other than the clients and servers shown may be included in system 100. In an implementation, one or more additional servers may operate as a cloud infrastructure control, from which servers and/or clients of the cloud infrastructure are monitored, controlled and/or configured. For example, some or all of the techniques described herein may operate on said cloud infrastructure control servers. Alternatively, or in addition, some or all of the techniques described herein may operate on servers such as servers 122.

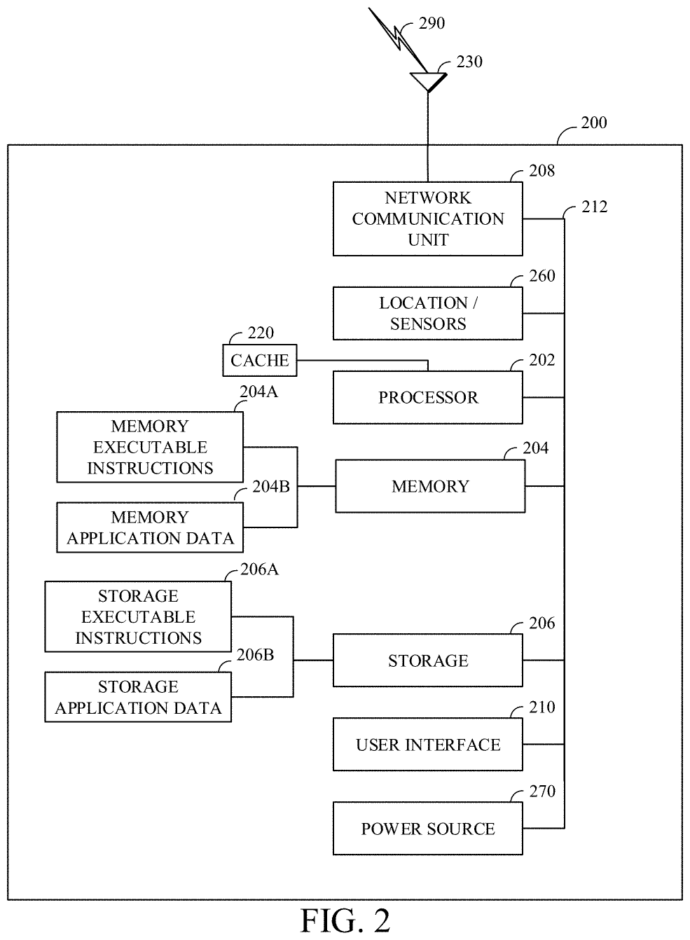

FIG. 2 is a block diagram of an implementation of an internal configuration of a computing device 200, such as a client 112 or server device 122 of the computing system 100 as shown in FIG. 1, including an infrastructure control server of a computing system. As previously described, clients 112 or servers 122 may take the form of a computing system including multiple computing units, or in the form of a single computing unit, for example, a mobile phone, a tablet computer, a laptop computer, a notebook computer, a desktop computer, a server computer and the like.

The computing device 200 can include a number of components, as illustrated in FIG. 2. CPU (or processor) 202 can be a central processing unit, such as a microprocessor, and can include single or multiple processors, each having single or multiple processing cores. Alternatively, CPU 202 can include another type of device, or multiple devices, capable of manipulating or processing information now-existing or hereafter developed. When multiple processing devices are present, they may be interconnected in any manner, including hardwired or networked, including wirelessly networked. Thus, the operations of CPU 202 can be distributed across multiple machines that can be coupled directly or across a local area or other network The CPU 202 can be a general purpose processor or a special purpose processor.

Random Access Memory (RAM) 204 can be any suitable non-permanent storage device that is used as memory. RAM 204 can include executable instructions and data for access by CPU 202. RAM 204 typically comprises one or more DRAM modules such as DDR SDRAM. Alternatively, RAM 204 can include another type of device, or multiple devices, capable of storing data for processing by CPU 202 now-existing or hereafter developed. CPU 202 can access and manipulate data in RAM 204 via bus 212. The CPU 202 may utilize a cache 220 as a form of localized fast memory for operating on data and instructions.

Storage 206 can be in the form of read only memory (ROM), a disk drive, a solid state drive, flash memory, Phase-Change Memory (PCM), or any form of non-volatile memory designed to maintain data for some duration of time, and preferably in the event of a power loss. Storage 206 can include executable instructions 206A and application files/data 206B along with other data. The executable instructions 206A can include, for example, an operating system and one or more application programs for loading in whole or part into RAM 204 (with RAM-based executable instructions 204A and application files/data 204B) and to be executed by CPU 202. The executable instructions 206A may be organized into programmable modules or algorithms, functional programs, codes, and code segments designed to perform various functions described herein. The operating system can be, for example, a Microsoft Windows®, Mac OS X®, or Linux® operating system, or can be an operating system for a small device, such as a smart phone or tablet device, or a large device, such as a mainframe computer. The application program can include, for example, a web browser, web server and/or database server. Application files 206B can, for example, include user files, database catalogs and configuration information. In an implementation, storage 206 includes instructions to perform the discovery techniques described herein. Storage 206 may comprise one or multiple devices and may utilize one or more types of storage, such as solid state or magnetic.

The computing device 200 can also include one or more input/output devices, such as a network communication unit 208 and interface 230 that may have a wired communication component or a wireless communications component 290, which can be coupled to CPU 202 via bus 212. The network communication unit 208 can utilize any of a variety of standardized network protocols, such as Ethernet, TCP/IP, or the like to effect communications between devices. The interface 230 can comprise one or more transceiver(s) that utilize the Ethernet, power line communication (PLC), WiFi, infrared, GPRS/GSM, CDMA, etc.

A user interface 210 can include a display, positional input device (such as a mouse, touchpad, touchscreen, or the like), keyboard, or other forms of user input and output devices. The user interface 210 can be coupled to the processor 202 via the bus 212. Other output devices that permit a user to program or otherwise use the client or server can be provided in addition to or as an alternative to display 210. When the output device is or includes a display, the display can be implemented in various ways, including by a liquid crystal display (LCD) or a cathode-ray tube (CRT) or light emitting diode (LED) display, such as an OLED display.

Other implementations of the internal configuration or architecture of clients and servers 200 are also possible. For example, servers may omit display 210. RAM 204 or storage 206 can be distributed across multiple machines such as network-based memory or memory in multiple machines performing the operations of clients or servers. Although depicted here as a single bus, bus 212 can be composed of multiple buses, that may be connected to each other through various bridges, controllers, and/or adapters. Computing devices 200 may contain any number of sensors and detectors that monitor the device 200 itself or the environment around the device 200, or it may contain a location identification unit 260, such as a GPS or other type of location device. The computing device 200 may also contain a power source 270, such as a battery, so that the unit can operate in a self-contained manner. These may communicate with the CPU/processor 202 via the bus 212.

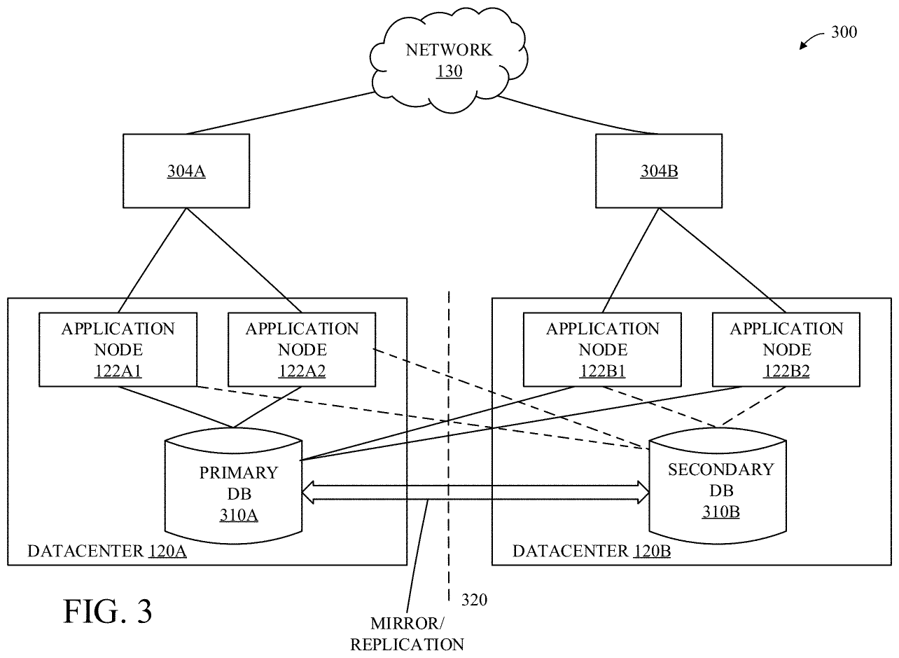

FIG. 3 is a block diagram of an implementation of a high availability processing system. The illustrated distributed computing system 300 can be, for example, an implementation of datacenter 120 and network 130 of FIG. 1. Broadly, the system 300 includes load balancers 304A, 304B and two datacenters 120A, 120B. The load balancers 304A, 304B are coupled to a telecommunications network graphically depicted by network 130. Load balancers 304A, 304B may also include reverse proxy load balancers.

The datacenter 120A includes a primary database 310A, and the datacenter 120B includes a secondary database 310B. The datacenters 120A, 120B operate in such a manner that the secondary database 310B can provide an exact or substantially exact mirror of the primary database 310A. A line 320 is used to graphically emphasize the logical boundary between datacenters 120A and 120B. Depending upon the intended application, the databases 310A, 310B may be implemented using, for example, a relational database management system (RDBMS), an object database, an XML database, flat files, or the like.

Each datacenter can include two application nodes 122A1, 122A2, 122B1, 122B2 (collectively or individually by way of example 122), although a greater or lesser number can be used depending on the implementation. The application nodes can be implemented using processing threads, virtual machine instantiations, or other computing features of the datacenters that run programs on behalf of remotely sited clients, and exchange related data with such clients via the network 130. In connection with running these programs, occasions arise for the application nodes to store and retrieve data, with the databases 310A and 310B filling this role. In an implementation, each of the application nodes connects to a single primary database, regardless of whether said database is located in the same datacenter as said application node. For example, a primary database may be read/write and a secondary database may be configured to be read-only such that it mirrors changes from the primary database. Requests to the system 300 may be routed to the application nodes in the datacenter of the primary database first, followed by the other datacenter. In a failover situation, the secondary database may become read/write with the formerly primary database switched to mirror the secondary database (which becomes the primary database). In this situation, each application node can be reconfigured to point to the secondary database (now the primary database) as shown by the dashed lines.

As mentioned above, each datacenter 120A, 120B may have its own load balancer 304A, 304B. Each load balancer may be configured to direct traffic to respective servers and processing nodes located within its datacenter. In regard to proxy services, in one example the load balancers 304A, 304B are configured to provide a single Internet-delivered service to remote clients via the network 130, where this service is actually provided by a server farm composed of the computerized servers of the datacenters 120A, 120B. The components 304A, 304B also coordinate requests from remote clients to the datacenters 120A, 120B, simplifying client access by masking the internal configuration of the datacenters. The components 304A, 304B may serve these functions by directing clients to processing nodes as configured directly or via DNS. Load balancer 304A, 304B can be configured for sticky sessions. With sticky sessions, the load balancer can attempt to forward all requests from a client to the same application node 122A1, 122A2. Different sticky session implementations are available. For example, in an implementation, a load balancer can be configured to direct all requests associated with a particular session to a same application node, so long as that node is available.

In regard to load balancing, the components 304A, 304B can be configured to direct traffic to the secondary datacenter in the event the primary datacenter 120A experiences one of many enumerated conditions predefined as failure. The load balancing functionality of the components 304A, 304B can be provided as separate components or as a single component.

The features and implementations associated with systems and methods disclosed herein can be included, in whole or in part, as part of one or more graphical display regions for outputting data to display for a user. In an implementation, a graphical display region can comprise part of a software graphical user interface constituting data that reflect information ultimately destined for display on a hardware device. For example, the data can contain rendering instructions for bounded graphical display regions, such as windows, or pixel information representative of controls, such as buttons and drop-down menus. The rendering instructions can, for example, be in the form of HTML, SGML, JavaScript, Jelly, AngularJS, or other text or binary instructions for generating a graphical user interface on a display that can be used to generate pixel information. A structured data output of one device can be provided to an input of the hardware display so that the elements provided on the hardware display screen represent the underlying structure of the output data.

### Workflow Creation and Editing

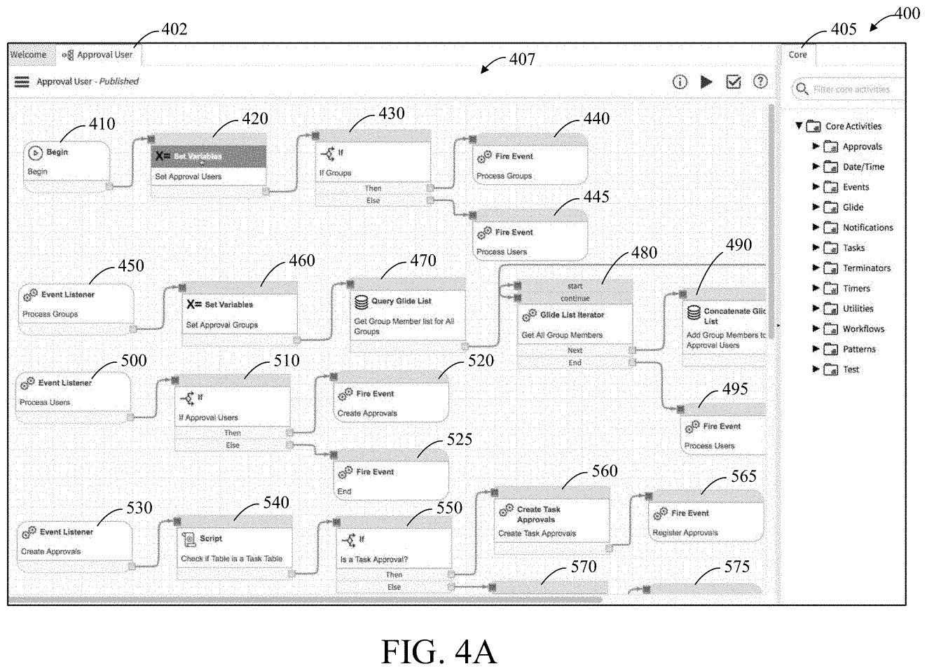

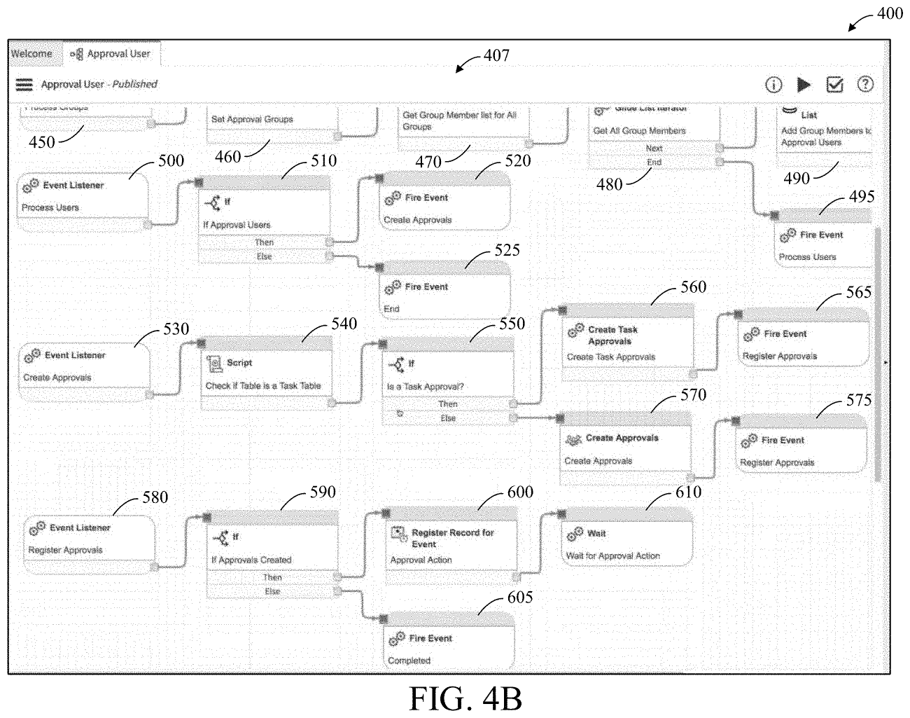

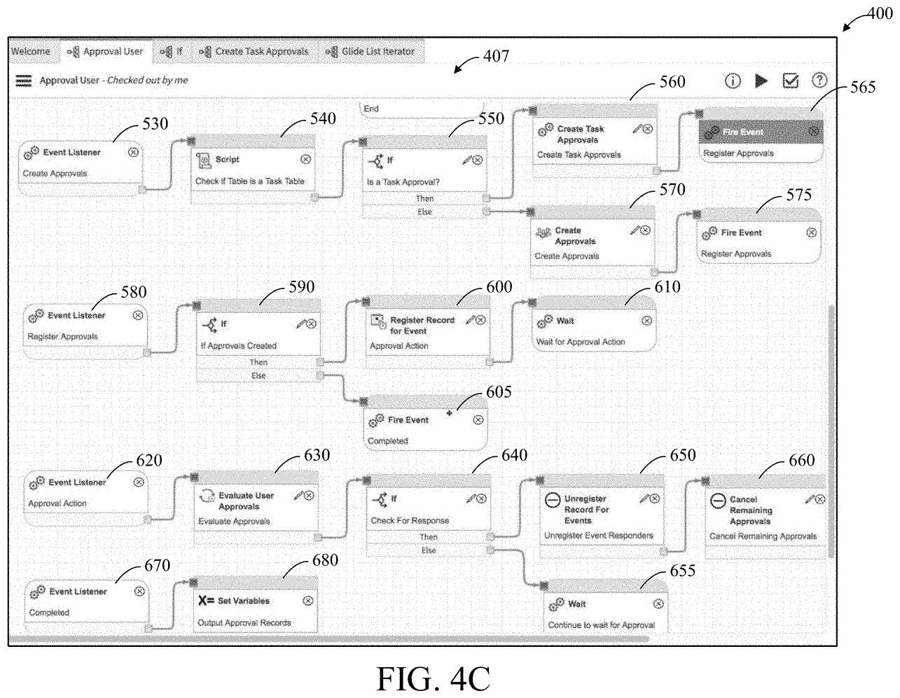

FIGS. 4A-4C are parts of a screen shot 400 illustrating an example implementation of a user interface for working with a workflow 407 comprising a number of workflow activities. The workflow 407 may be implemented in a platform of a data service provider. In this example, an Approval User workflow 407 is shown, which may be identified via a tab 402. A region of the display may also be set up for showing core activities 405, possibly organized via a folder hierarchy. Core activities 405 can include primitive workflow activities that provide basic functionality and are provided to a user as a part of the workflow system and workflow activities that are created within the workflow system, either by the user or provided out-of-the-box with the workflow system (e.g., a script activity with a particular script; a sub-workflow including a configuration of workflow activities provided by the user).

In an implementation, primitive workflow activities can include those described below in Table 1 below. Depending on the implementation, there may be more or less primitive activities.

TABLE 1
Example primitive workflow activities

| Activity | Category | Description |
|---|---|---|
| Begin | Utilities | Begin workflow. The starting activity for all workflows. |
| Continue | Terminators | Continue returns control back to the calling parent. The parent |
| | | continues along the transition path without waiting for the child |
| | | workflow to finish. |
| End | Terminators | End terminates the workflow completely. The workflow engine does |
| | | not process any further activities in the workflow. If the workflow is |
| | | an activity for a parent workflow, it returns to its parent. |
| Entry Port | Events | Entry port is a special type of event listener that can act as an entry |
| | | point to the workflow when it is used as an activity. |
| Event | Events | Event Listener, when triggered, starts a sequence of activities along |
| Listener | | a path in a workflow. |
| Fire Event | Events | Fire Event causes the workflow engine to immediately trigger a |
| | | specified event listener activity. |
| Script | Utilities | Script runs a script that you define. |
| Set | Utilities | Set Variables assigns values you specify to a workflow's local and/or |
| Variables | | output variables. |
| Wait | Terminators | Wait terminates the execution path but does not return control to the |
| | | calling parent. The workflow engine may continue processing other |
| | | activities in the subflow. |

Other workflow activities can be provided by default. Such activities can be implemented as a workflow themselves by using the primitive workflow activities described above, or, in an implementation, can be implemented as a primitive activity instead. The activities described below are example and certain activities might not be available, certain activities may be modified, or other activities may be made available depending on the implementation.

An Absolute Timer workflow activity can be provided that pauses the workflow until a specific time and date, which can have a Schedule Time input that indicates the time and date until which the workflow should pause. Similarly, a Relative Timer workflow activity can be provided that pauses the workflow for a specified duration.

An Approval User workflow activity can be provided that creates one or more individual user approval records for specified users. In an implementation, the Approval User workflow activity can be implemented to use inputs, outputs, and exit conditions such as those described in Tables 2-4. An Approval Group workflow activity can be provided as well that creates one or more individual user approval records for users associated with a group. Similar inputs, outputs, and exit conditions can be used for the Approval Group workflow activity.

TABLE 2
Example inputs to Approval User workflow activity

| Field | Description |
|---|---|
| Approvers | Specify who needs to approve this document. |
| Users | The users for which the system will generate approval records. To select one or |
| | more users from the system directory, click the lock icon. If no user is selected, |
| | the activity automatically sets the approval to Approved. Workflow only |
| | manages approval records generated by the Approval User activity. After |
| | starting the workflow, newly added approvals do not affect the workflow |
| | context. |
| Groups | Groups whose members should also receive approvals. Note that this is |
| | different than the Group Approval activity, which creates a group approval in |
| | addition to the individual approvals. To select one or more users from the |
| | system directory, click the lock icon. |
| Approval for | Specify the table and record to be approved. |
| Table | The table containing the record to be approved. |
| Approving | The individual record to be approved. |
| Conditions for | Specify what needs to happen for the record to be considered approved. |
| Approval | |
| Wait for | A choice between different approval logics to determine which individual |
| | approvals result in approval of the activity's approval. Options can include: |
| | Anyone to approve: Any user can approve and the first approval causes |
| | the activity to complete with a result of approved. |
| | Everyone to approve: All users must approve (see below for how a |
| | rejection is handled). |
| When anyone | A choice between different approval logics to determine which individual |
| rejects | rejections result in rejection of the activity's approval. Options can include: |
| | Reject the approval: Immediately complete the activity with a result of |
| | rejected. |
| | Wait for other responses before deciding: Wait until we get other |
| | responses before making an approval or rejection decision. This allows users to |
| | change their mind until a decision is made. |
| | Note: Note that if Wait for is set to Anyone to approve then a single approval |
| | will cause the activity to complete with a result of approved even if one or |
| | more users reject. |

TABLE 3
Example outputs from Approval User workflow activity

| Field | Description |
|---|---|
| Response | The final status of the approval when this activity |
| | has finished executing. |
| | Possible values can include: |
| | Not yet requested |
| | Requested |
| | Approved |
| | Rejected |
| | Cancelled |
| | No longer required |
| | More information required |
| | Duplicate |
| Approval | A list of the approval records generated by this activity. |

TABLE 4
Example exit conditions for Approval User workflow activity

| Field | Description |
|---|---|
| Cancelled | The exit path the system follows if the approval was |
| | cancelled. |
| Rejected | The exit path the system follows if the approval was rejected. |
| No Longer | The exit path the system follows if the approval became |
| Required | no longer required. |
| Approved | The exit path the system follows if the approval was |
| | approved. |

A Cancel Remaining Approvals workflow activity can be provided that cancels any outstanding approvals for a specified record. If there are any unapproved approval records attached to the specified record when this activity is invoked, the system cancels them. The Cancel Remaining Approvals workflow activity can take as input The name of the record (document) attached to the approvals to be canceled.

A Create Record workflow activity can be provided that creates a database record in a specified table. The Create Record workflow activity can take as input a table name, template to use for creating the record, and an identification of business rules (e.g., scripts) that should be executed when the record is created. By specifying a business rules, default business rules that might have otherwise executed may be overridden and not executed. The Create Record workflow activity can output a table in which the new record is created an a document indicating the record that was just created.

A Create Task workflow activity can be provided that adds a task record to a specified task table. The Create Task workflow activity can take as inputs the fields described below in Table 5 and provide as an output a task record ID that can be made available to a parent workflow as an output variable.

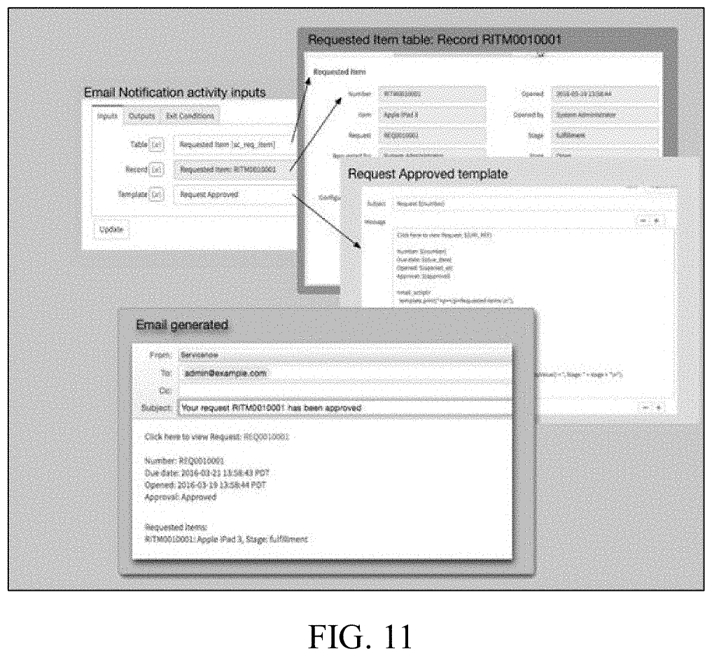

An E-mail Notification workflow activity can be provided that creates and sends an e-mail such as based on data found in a specified table and record. The E-mail Notification workflow activity can take as input table, record, and template fields which can respectively describe the table containing the record that holds the data to be included in the email, the record holding the data that will be included in the email, and the email template on which to base the email. FIG. 11 includes a collection of screen shots that demonstrate the input configuration for the e-mail notification, an example item table and record identified as an input, an example template identified as input, and an example e-mail generated by the workflow activity as a result.

A Log Message workflow activity can be provided that writes a message to the workflow system log such as for debugging or tracing purposes. Inputs can include the message (which can be, e.g., a string or a JavaScript expression that evaluates to a string) and a source, which can be used to filter the log, and can be set to “workflow.”

A Queue Platform Event workflow activity can be provided that adds an event to a platform event queue, but does not immediately fire the event. The event processor can be configured to typically process the event within a time period, such as one minute. This activity can trigger business rules or email notifications that would normally be triggered by the event.

A Register Record for Event workflow activity can be provided that tells the workflow engine to watch for a specified event and to react to that event by triggering a specific event listener activity. Input can include the event that, when it occurs, should trigger an event listener, and the identity of the event listener to trigger when the event occurs. The event can, for example, be a system event (such as a change to a record in a specified table) or a workflow event (an event fired by another workflow activity).

The activities shown in the workflow 407 of FIG. 4A are now briefly identified and described.

The blocks of the workflow 407 represent activities that take place, and may contain local variables that can maintain a state, i.e. can encompass a defined state/process. The workflow 407 starts at the begin block 410 and proceeds to setting approval users 420. If the users are in groups 430, then an event is fired 440 to process the groups—otherwise, an event is fired 445 to process the users. An event listener for processing groups 450, upon receiving the event proceeds to setting approval groups 460 and a group member list for all groups is retrieved from the database 470. Each of the group member list is processed via the Get All Group Members glide list iterator 480. Glide list iterator is an example of a database access activity that can be configured to iterate through database records which satisfy query criteria determined based on a configuration of glide list iterator 480 (e.g., when placed in the workflow), based on input provided to the glide list iterator 480 from a prior workflow activity, based on platform or system configuration settings, or a combination thereof. Unless it is the last record in the list, group members are added to the approval users 490. If it is the last record, then an event is fired to process the users 495.

The Process Users event listener 500 begins a process 510 to determine if the users are approval uses, in which case it fires an event for creating approvals 520—otherwise, it fires an event to end the process 525. The Create Approvals event listener 530 begins a process to determine if the table is a task table 540. A process 550 then determines if it is a task approval. If so, task approvals are created 560 and an event is fired to register them 565. If not, approvals are created 570 and an event is fired to register them 575.

The Register Approvals event listener 580 begins a process 590 to determine if the approvals have been created, and, if so, initiates an approval action entry 600 and waits for an approval action 610—otherwise, a completion event is fired 605.

The Approval Action event listener 620 begins a process 630 to evaluate the approvals, and then a test is performed 640 to check for a response. If there is a response, the event responders are unregistered 650 and remaining approvals are canceled 660—otherwise, the system continues to wait for an approval 655. The Completed event listener 670 begins a process of outputting the approval records 680.

Workflows can be organized within horizontal lanes in the workflow canvas. For example, as shown in FIGS. 4A-C, activities 410-440 can be organized into one lane, activities 450-490 into a second lane, activities 500-525 into a third lane, and so forth. In the workflow canvas shown in FIG. 4A, the horizontal lanes are overlapping without a graphical indication demarcating the boundaries between the horizontal lanes. However, in an alternative implementation, the horizontal lanes can be separated by a graphical boundary (e.g., a line) and activities associated with different start points (e.g., begin activity, event port, event listener) can be segregated visually and/or functionally by the horizontal lane demarcations.

### Element Mapping

According to an implementation, API for workflows and activities may be symmetrical. Mapping may be used as a mechanism for specifying the passing of data between activities and establishing chains of variable assignments. The mapping stored may be a reference to another variable that the mapping provider can resolve, which enables the transfer of data between activities without the use of global variables (i.e., the workflow context may be private). Input variables may be mapped from a parent (via the workflow scope's inputs or local variables). Locals variables may be used for keeping state in a scope, for passing scope private data between activities, and for persisting a state across events (e.g., for pauses where the workflow stops running on a particular thread). Output variables may be used for returning data out of a workflow scope to a parent scope. In an application scoped workflow, the use of mapped variables can provide controlled, discrete access to generally protected data to an out-of-scope workflow. A workflow in a scope could call a workflow from a different scope and map data into and out of it, where that particular workflow normally not have direct access to this data.

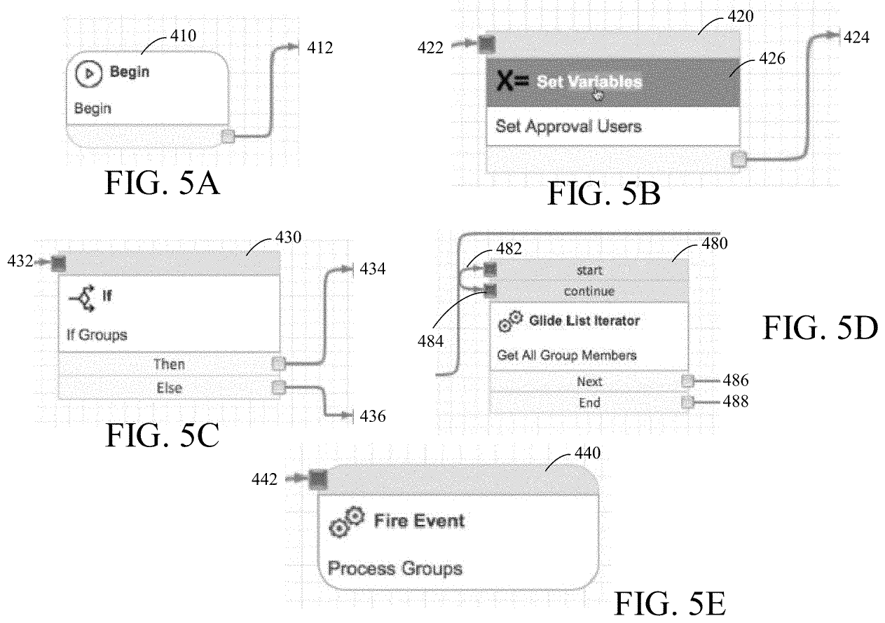

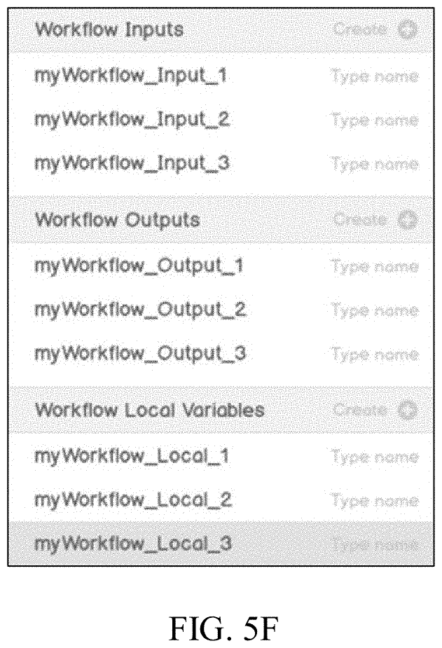

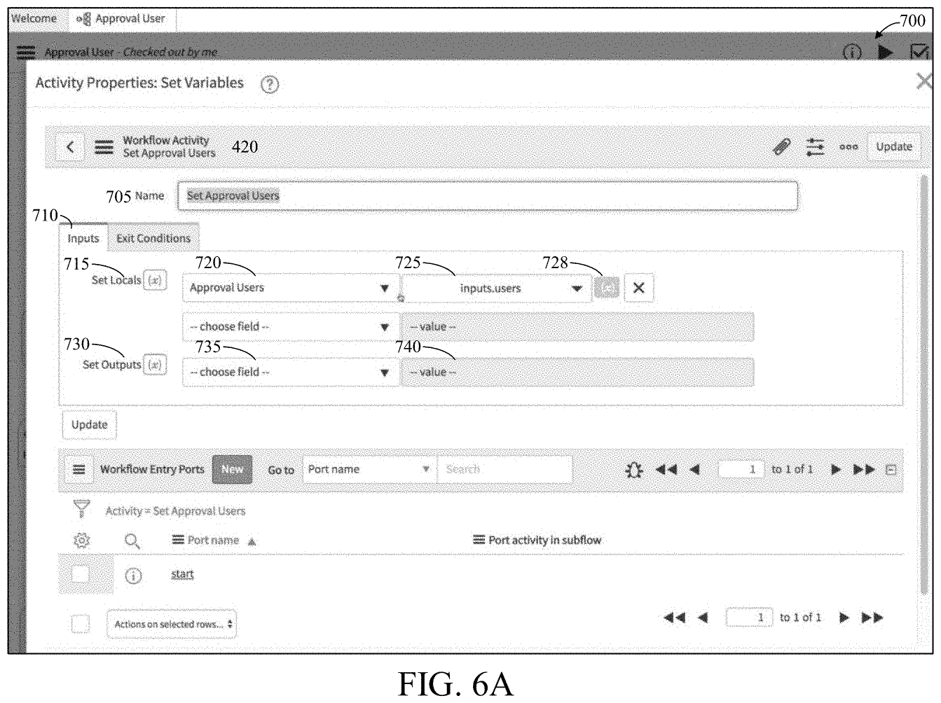

Select activities described above and discussed in more detail. FIGS. 5A-E are graphical images of example activity blocks of a workflow. In FIG. 5A, a begin block 410 is shown having a single output 412. This output can provide initial variables that are used in the process. In FIG. 5B, the Set Approval Users block 420 comprises an input 422 and an output 424. The user can select the Set Variables box command 426 that permits the user to interact with the activities variables. The input and output definitions provide a unification of the API exposed by workflow activities and workflows so that there is a single API for passing data between each process artefact.

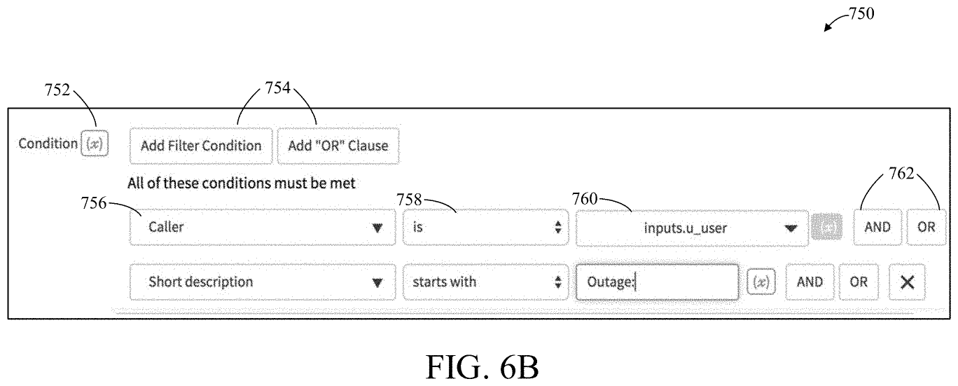

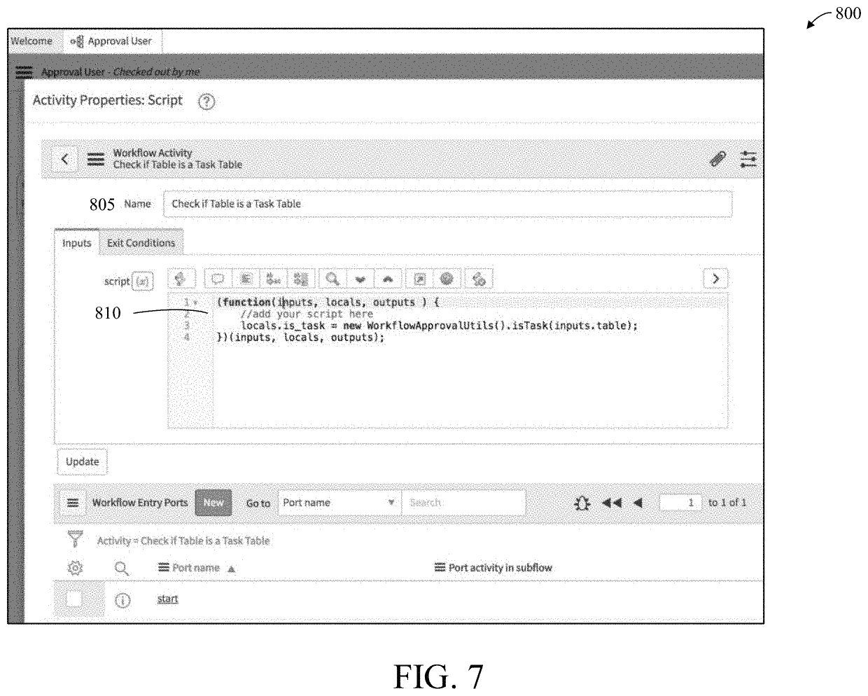

Selecting this can bring up a display screen, such as that shown in FIG. 6A, which is an example screen shot 700 of a form for the Set Variables for the Set Approval Users block 420. The form has a name field 705 that permits entry of the name, and allows the entry of inputs via an input tab 710. A group of fields is provided for setting local variables 715, and a data selection field 720 allows the selection of a data element name. In an implementation, only variables of the correct type are made visible to the user in order to facilitate selection.

A static value can be provided in a value entry field 725—however, although a hardcoded value could be provided here, a user may also provide a mapping of where the value may be fetched from (element mapping). In the example shown, a mapping button 728 is pressed that toggles the input field to a mapping mode and allows the element to be mapped—here, to provide that the value is fetched from an input.users variable. Similarly, a group of fields is provided for setting outputs 730, and a data selection field 735 allows the selection of a data element name. A value can be provided in a value entry field 740, but a mapped element may also be provided here in place of a fixed variable. The model permits each entry field to be made mappable, and a UI assist may be provided so that the mapping data is intuitive and the variables are discoverable. In an implementation, inputs are passed in so that the dependencies are explicit. FIG. 5F is a screenshot of an implementation showing a selected workflow's inputs, outputs, and local variables.

FIG. 6B is an example screen shot 750 of the use of conditions for mapping. The conditions can evaluate against all variables including a comparison of variables with other variables. The condition element 752 provides for UI elements, such as the buttons 754 for adding a filter condition or an “OR” clause. A listing is provided of conditions that must be met. For example, as shown, the Caller variable 756 condition has a condition “is” (equal to) 758 inputs.u_user 760 variable. Additional conditions can be chained together via the use of AND and OR buttons 762.

This element mapping allows the user, at a core architectural level, to provide two new application program interface (API) points: a get mapping API point, and a set mapping API point. When a user sets a mapping, the system overrides respective behaviors of get value and set value methods. Thus, instead of hard coding “John Smith” to a user reference, a variable can be referenced, e.g., by setting a mapping that references a variable that contains the user that you want to use, (for an approval, etc.). The use of element mapping allows moving data around within and between forms, and pass data entities between different workflow activities.

To implement this, when a caller executes a getValue command to get the value of the field, this call is intercepted and it can be determined that mapping has been specified on the field and the data is obtained from the specified mapping. On the input mapping, the variables are stored using a special syntax, which is detected when the call is intercepted so that the contents of the variable can be used. The behavior of the getValue for the field is overwritten.

Conversely, for output mapping, the behavior of the setValue is overridden. When a user calls setValue for a field, instead of just setting that variable to a static value, it is possible to determine that this output has been mapped to another location (looking at the location referenced.

The activity modules can use three types of variables: inputs, locals, and outputs. Input variables are elements whose values are available as inputs to either a workflow, sub-flow or workflow activity. The input variables may become part of the API to the workflow or activity. Local variables are elements whose values are private to the workflow or activity. Local variables provide a way to communicate data and state between activities on a single flow or provide state to an activity as it iterates or waits. Output variables are elements whose values are available as outputs to either a workflow, sub-flow or workflow activity. The output variables may become part of the API to the workflow or activity.

An implementation of a design herein may allow any workflow to behave like an activity with an identical API for input/outputs, and allows any activity to be implemented as a sub-flow (however, in some implementations, primitives from which other activities may be implemented, e.g., a script activity, may not be implementable as a sub-flow).

These can divide the concept of a workflow scope, so that a user, workflow, or activity, can pass in inputs to the workflow. To the extent that, on a given workflow, the multiple activities on the canvas should share data between activities on the canvas, one can do so without using output variables, and without using variables, by using local variables to store the state of an activity across activities.

A call to a workflow can take a certain set of inputs and return a certain set of outputs, and the output variables may be set by the activity. One can assign input variables on the activities contained in that workflow, which either come from the parent calling workflow's input or from local variables. Then on the output side, an output can be mapped to either local variables or output variables. Thus, one can set a local variable to have a value stored off in this workflow scope that can be used in another workflow activity, or, an output variable can be sent which is actually returned to the caller of the entire workflow. The input mapping overrides the getValue, and output mapping overrides the setValue.

By way of example, if getValue is called on an input called “condition,” this call can resolve any variables contained in this condition first, and then the value of the get value function may be overwritten. In another example, a piece of JavaScript (upon what the actions, according to an implementation, are ultimately based) sets a variable called “result.” The overridden field indicates that result equals a different variable (e.g., x). When the field indicates that the result should equal a string “Joe,” instead of just setting the variable to “Joe,” a mapped output is used and thus overrides the behavior of the setValue method. Instead of simply setting this variable to its defined value “Joe,” it considers what the mapping points to (here “x”) and sets the value to what is being pointed to by x, thereby overriding the behavior of setValue in this situation. It is the parent context, i.e., the caller, that provides the mapping, i.e., where to get the inputs from, and where to set the outputs. This may be achieved by the caller passing references to a location of the mapped values that can be used by the called routine.

The script 540 is an example of a script action. A run script runs on the parent workflow scope. When the user selects the script action, a script action display screen 800 is shown that identifies the script name as “Check if Table is a Task Table” 805. You can see it just has access to setting a local variable (locals.is_task), based on an input (locals). The JavaScript reads the table name since this is a task, and then sets a local variable name called is_task. The routine does not need to know what any callers to this workflow are using is_task for. The variables are just input and output parameters. And the caller manages how to deal with the parameters at the input side and how to deal with the return value on the output side.

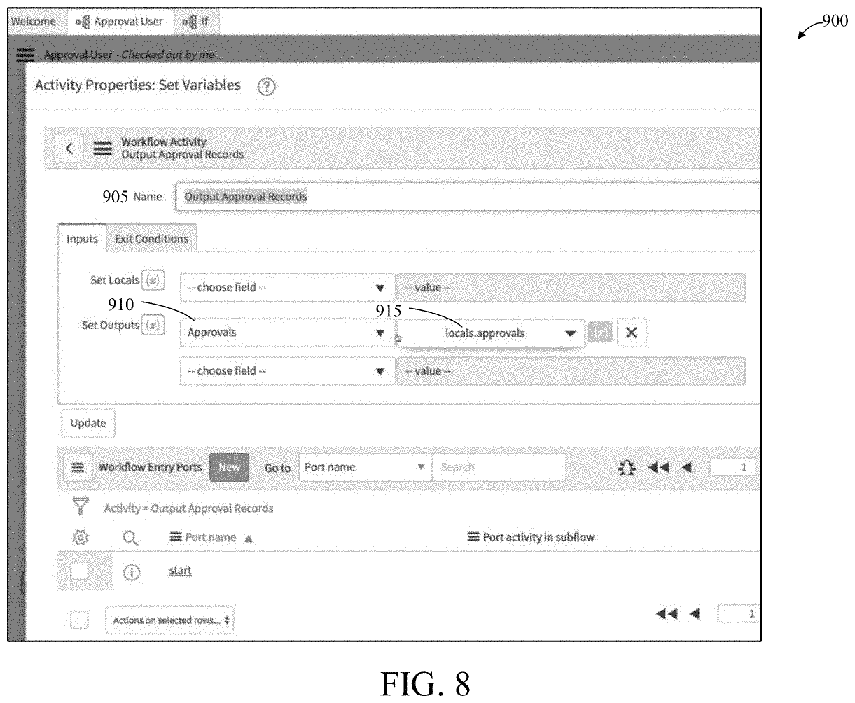

The Output Approval Records block 680, when selecting set variables, may display a screen as shown in FIG. 8, which illustrates a variable setter activity. It allows a user to indicate on the inputs to set an output. In this example, the locals.approvals is on the outputs, and then the locals.approvals may be reused in other places. For the output mapping, the local variables can be mapped to the output.

The activity may have built into it the things that are the outputs. For example, an approval activity might have outputs of the record being approved the users set to approval, whether it got approved, true or false. One can choose whether to map them, and if so, map them to a local variable or two for output on the call. This provides a convenient way of passing variables around, where the implementation of the lower-level activities do not know anything about the callers.

If locals.approvals is not mapped, then this local variable does not get upset. The output is being stored in that variable. It is setting the value of an output—the output name is Approvals, the location it's setting approval to is locals.approvals. Here, an activity “create ask approval” is being called from an activity called “approval user.” Create task approvals has an output variable, when called, of approval. When this is called from approval user, it is taking the output of create task approval and setting it to a local variable on the approval user workflow called locals.approvals. This would is equivalent to saying locals.approvals equals approvals. Then, the return value is being set based on the return value which is the approval from here, or setting it to locals.approvals.

In an implementation, three types of mapping can be provided: a) basic mapping, which can include completely overwriting a field with the mapped variable; b) string concatenation, which can include one or more static values being concatenated with one or more mapping values; and c) more complex mappings, such as an if condition, which may be similar to the string concatenation type, but with underlying logic requiring additional user input through user interface elements. In one example of complex mapping, one can specify a table and then select a local variable to store information from the table.

FIG. 5C is a block diagram of an if element, the If Groups action 430. It has one input 432, which, in this example is received from the output of the Set Approval Users action 420. It has two outputs, a first depending on whether the if condition is true 434, and a second depending on whether the if condition is false 436.

A mapping expression may be resolved into a value when the element's value is retrieved or assigned from either Java (getValue/setValue) or JavaScript (dot-walk). Any element may be able to turn mapping on or off via a dictionary attribute.

Two additional abstractions may be utilized needed for element mapping: Mappers and MappingResolvers. A Mapper can handle storing and retrieving the mapping expression for a given Element. When an element is saved or loaded, the element's mapper may be asked to save or load any associated mapping for that element. A single Mapper implementation may store the element's mapping off-row in a sys_element_mapping table when an element is initialized or saved.

A MappingResolver can handle evaluating the mapping expression into a value. The resolver can understand the scope in which the expression makes sense. If an element has both a mapping and a resolver defined, then the resolver may be asked to get or set the value of the element. If either of those is missing, the element's static value may be used.

According to an implementation, mapped elements may utilize the following rules: 1) mappings may be bi-directional, i.e., one can get a value from the location specified in a mapping (pull) and set a value to the location specified in a mapping (push); 2) if an element has both a mapping and a resolver, the mapping can take priority over the element's static value—getValue will retrieve the value pointed to by the mapping, setValue will set the value pointed to by the mapping, and if an element doesn't have both, getValue/setValue use the local fValue; 3) an element may be considered to have changed if either the value of the element or the mapping has changed. Changes in a resolved value of the mapping may not be detected. The specific Mapper and MappingResolver implementations may be pluggable, and individual elements can select the implementation to use via an attribute on the element's dictionary record.

A workflow/activity has a design-time model that defines the variables used by that workflow or activity. At run-time, a copy is made of that design-time model that can be used for the specific execution instance that is about to be run.

According to an implementation, direct access is not allowed to a workflow/activity internal runtime state from script. Instead an ExecutingActivity assembles a run-time copy of the variables into a JavaScript map. At the same time, any input variables that have element mappings are resolved into values, and only the resolved JS map is put into scope for the activity execution. This allows the activity scripts to be executed with a standardized evaluator. After execution of the activity script, any changes in the variable map may be applied to the original variable elements. The mapping resolver can automatically push those values to the correct destination variable if they have a mapping.

According to an implementation, the notation adopted for resolving mapped values can be the double mustache {{mapping}}. In this scheme, the user is not exposed to the notation, but instead is presented with a pill capsule UI that reflects the value of the mapping, e.g., “Hello [inputs.u_manager] you have messages waiting approval for [inputs.u_manager.company]”. In a Single Selection case, the user can select a field directly from the Field Selector. The Field Selector can make available for selection only Elements that are compatible with the field being mapped. In a Concatenated String of Inputs case, string fields can be comprised of values from multiple fields to form a single string value. The Pill UI facilitates interpolation of static values with multiple mapped values.

### Looping, Iteration, and Event Control

Another element that may be utilized for flow control is illustrated in FIG. 5D, which is an iterator block that permits performing iterations on the canvas. In this example, it is the Get All Group Members block 480, which comprises two inputs 482, 484 for handling a start and continue event that is coming in into the activity, respectively. The very first iteration on the glide list enters via the start 482, which could perform initializations, etc. Subsequent iterations then enter via the continue 484, which might presume that certain initializations and setups have been performed. Depending on what happens within the activity, it will end with one of two outputs: next 486 or end 488. Thus, the user can control the flow within the implementation of this activity that is exposed by the ports on the actual calling of this activity. The activities are not limited to a maximum of two inputs and outputs—an activity can have any number of each. This just provides a framework for a very flexible configuration of activities within a workflow.

In addition to looping and iteration, the workflow can make use of events which can be created by event emitters and event listeners (also known as event handlers) which listen for certain events. Events can be used on the canvas when defining workflows as having multiple start points (e.g., by using event listeners).

Events may be considered the API for workflows, and may determine a flow of execution in a workflow. The starting of a workflow may be at an event listener or port, and the resuming of a workflow may be at an event listener or port. An event listener can listen for events emitted within the current workflow context or child workflow contexts. An event port can be exposed to a calling workflow and thus can receive events from a parent workflow to initiate execution of the current workflow, such as when iterating over a set of data in the parent workflow. An event port can be exposed as a port to the parent workflow to which transitions can be wired within the parent workflow.

Events can flow backwards along a path of execution within a workflow and bubble up workflow scopes. Event names can conform to a representational state transfer architecture (RESTful) syntax and support wildcards e.g. and event like “/error/javascript” could be caught by a listener running on “/error/*”. Event handling at workflow authoring time may be exposed as an un-parented activity. Event handling when calling an activity may be exposed as an additional entry-point so calling an event in the workflow canvas could mean drawing a line to that event. Out-of-band activities may be provided for a record watcher to ask it to wait for some operation and fire an event into the current context when that event occurs.

Event bubbling functionality can be provided. Events can be fired by a event emitter into a specified context (e.g., for a particular workflow specified by the emitter or a default workflow, such as the current workflow). If no event listener or port matching the event is available in the current context, the event can be “walked up” to parent workflow contexts (e.g., workflows that have called the workflow of the current context) until a matching event port or listener is found or once all related contexts are evaluated without finding a matching event port or listener. Events can be used for exception handling since they bubble up to parent scopes, can be caught, and can be thrown.

FIG. 5E is a block diagram that illustrates a Process Groups event 440 that is a terminus of the initial portion of the workflow, and has a single input 442. The fired event 440 is caught by the Process Groups listener 450 which continues the workflow.

Some events may be used for pausing execution of the workflow and some may be used for resuming the workflow, but any event can potentially resume or start the workflow up. For example, if a user wants to insert a large number of records, it may be desirable to simply pause the workflow and wait for the records to be entered and approved. Once someone approves the records, the workflow is resumed.

Referring to FIG. 4C, the approvals are created 570 then the workflow pauses. The register approvals mechanism may be integrated with a record watcher that is told when these approvals the records get updated. The register approvals event 565 may register this with the record watcher.

The workflow resumes through the approval action event 620 once the records get updated (against this particular workflow) for approval action 620. The output from the approval action 620, is provided as an input to the evaluate approvals 630 action, and processing continues.

According to an implementation of this design, the record producing and event handling into the workflow can be put into the hands of the designer via activities and APIs. Thus, the Create Approvals is a sub-flow that iterates over a list of users and generates an approval record for each one. The Fire Event registers each approval record with a listening service via a Script API and specifies the callback class and the event to fire when one of the registered records meets the specified conditions. For the OnEvent handler, when a Record is approved, this handler executes when the event registered by FireEvent is fired by the Event Listener, indicating that one of the records registered has met the condition. The OnEvent handler's On ErrorExecutes when an error is fired into the workflow.

### Refactoring/Reusability

One ability of the workflows and canvas provided herein, according to an implementation, is the ability to refactor workflows. The workflows can be thought of as a functional programming language with exposed inputs and outputs. Thus, the workflows can be viewed as activities and vice versa. As noted above, drilling down into a particular activity represented by a visual block, e.g., by clicking on it, may reveal other visual blocks forming sub-activities until a particular drill-down is at the bottom level revealing the underlying code, such as JavaScript, at the core. According to the refactoring, a workflow is itself potentially a reusable activity in the workflow engine. A defined workflow has defined input and output variables that in certain cases may be desirable to reuse. Groups of activities can be selected on the workflow canvas to form another workflow. For example, a selected group of activities can be dragged out of the workflow canvas to form another workflow. As another example, a selected group of activities can be converted to another workflow through a different user interface action, such as a right click context menu action, a user interface that appears when a number of workflow activities are selected, or a combination thereof.

Thus, according to an implementation, using this refactoring tool, one can take a workflow and use it within another workflow. The activities selected, in an implementation, can be contiguous, with a single starting point and a single ending point. A workflow can be a callable unit with definable inputs and outputs. The refactoring is achieved by the workflow system determining the inputs and outputs for local variables that get touched by the selected two (or more) activities. Inputs and outputs are automatically created in a sub flow, i.e., the new workflow that is being created, and these are mapped automatically.

In more detail, and according to an implementation, the extracting of the selected activities into a new workflow may be achieved when the refactoring tool performs the following steps: 1) duplicating the selected activities into a new workflow, including all their values and mapping expressions; 2) parsing the activities for any mapping expressions or JavaScript which read from the available input or local variables; 3) parsing the activities for any mapping expressions or JavaScript which write to the available local or output variables; 4) duplicating the read input and/or local variables as inputs to the new workflow; 5) duplicating the written input and/or local variables as outputs of the new workflow; 6) removing the selected activities from the workflow, and replace them with an activity of the newly created workflow; 7) setting the new activity's inputs to be mapping expressions which reference the same sources in step 1; 8) setting the new activity's outputs to be mapping expressions which reference the same destinations found in step 2. This process thus replaces the previous activities with a single workflow by reading from and writing to all previously referenced sources in the same way, i.e., the inputs and outputs are the same, but the contents of the new workflow may differ. If fewer than all activities of a workflow are selected, then the resultant output represents a reusable sub-flow of the original workflow.

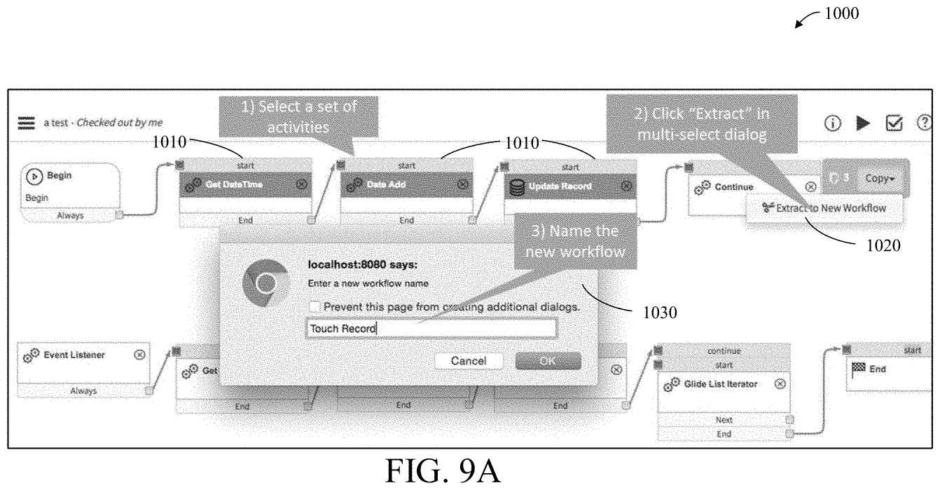

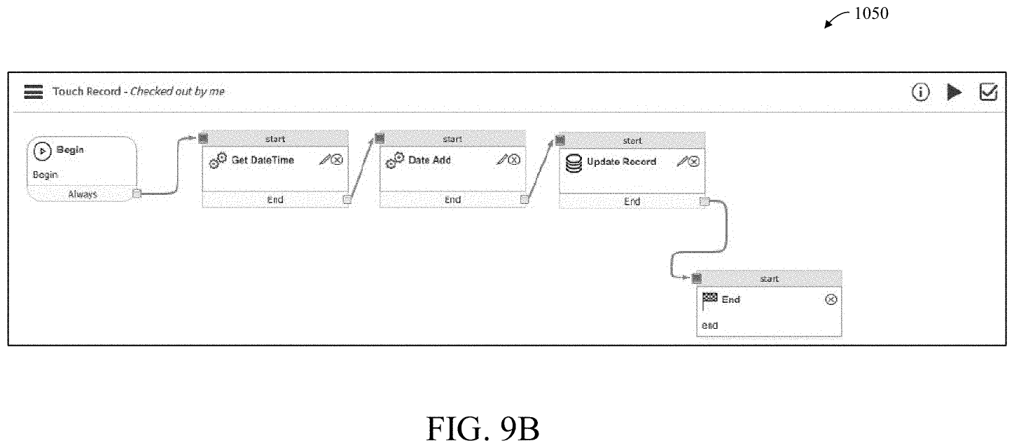

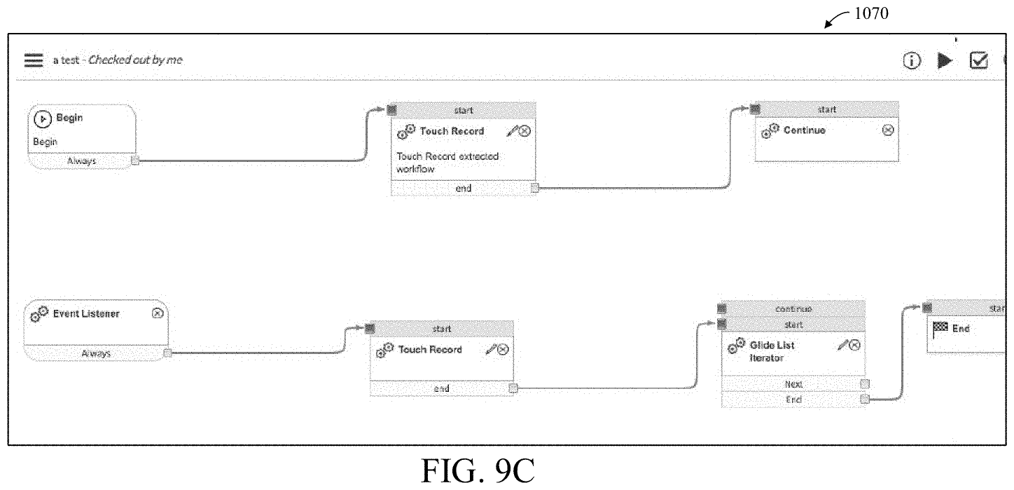

FIG. 9A is a screen shot 1000 of the canvas having blocks that may be used in creating the new workflow. As illustrated, a set of activities 1010 is selected and a multi-select dialog 1020, e.g., may be provided that allows an “Extract to New Workflow” option. A popup dialog box 1030 or other user interface input element may then be presented to the user for entering a new name of the workflow.

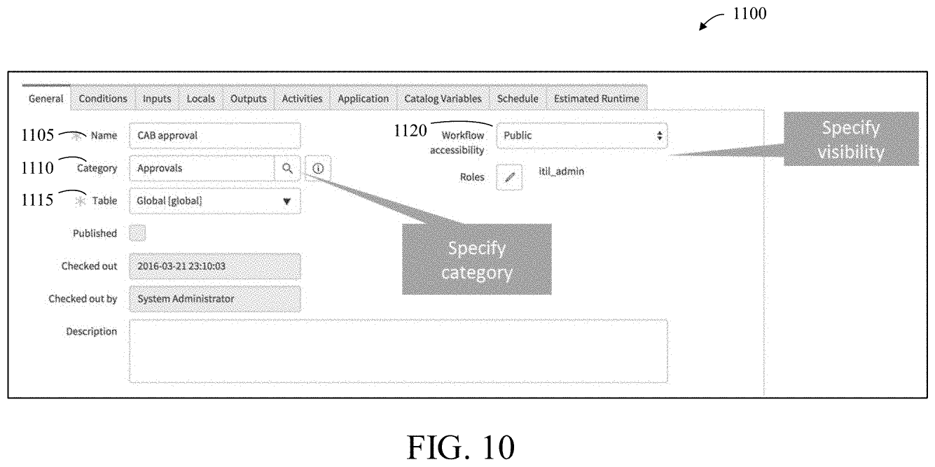

FIG. 9B is a screen shot 1050 of a canvas including activity blocks created from the extraction of the activity blocks selected in FIG. 9A into a sub-flow. The workflow system can automatically connect the appropriate entry point of the extracted activity blocks to a begin workflow activity and connect the appropriate exit point of the extracted activity blocks to an end workflow activity as shown. The sub-flow shown in screen shot 1050 can be assigned based on the input received to the pop-up dialog shown in FIG. 9A or from input to a workflow form, such as shown in FIG. 10.

FIG. 9C is a screen shot 1070 of the canvas shown in screen shot 1000 after extraction of the workflow activity blocks. The workflow system, after creation of the sub-flow can automatically replace the extracted activity blocks with an activity block of the sub-flow and connect the wires/transitions from the input and output ports of the sub-flow activity block to the appropriate activity blocks remaining in the workflow.

FIG. 10 is a screen shot 1100 of a workflow form illustrating how a new workflow can be made into a reusable activity, according to an implementation. The workflow is given a name 1105, and a category (here Approvals) is specified 1110. The table for access (here, the Global table) may be selected 1115. In the example shown, the workflow accessibility 1120 is made public. This then permits the new workflow to be utilized as a workflow activity component in a higher level workflow.

The workflow table structure can rely on a system metadata structure at its base from which a workflow element definition structure can extend. This element can then support extended definitions of a workflow structure and an activity definition structure. By utilizing a common parent, the relationship between the variables and workflow artifacts can be simplified. Leveraging the APIs and architecture provided by the variable restructuring make it possible to lift data sharing and event handling into the workflow model and into the hands of the workflow designer. As a result, the need to write script to execute the primitives of workflow

This architecture can help consolidate the variable handling into a single mechanism, and in doing so, it is possible to treat sub-flows as activities. This can be viewed as possibly eliminating workflow inputs, and then making workflows be activities, so that a workflow can use an activity input model. Thus, whether the element is a workflow, sub-flow or activity, the treatment of variables can be the same.

All or a portion of aspects of the invention described herein can be implemented using a general purpose computer/processor with a computer program that, when executed, carries out any of the respective techniques, algorithms and/or instructions described herein. In addition, or alternatively, for example, a special purpose computer/processor can be utilized which can contain specialized hardware for carrying out any of the techniques, algorithms, or instructions described herein.

The implementations of computing devices as described herein (and the algorithms, methods, instructions, etc., stored thereon and/or executed thereby) can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors or any other suitable circuit. In the claims, the term “processor” should be understood as encompassing any of the foregoing hardware, either singly or in combination.

For example, one or more computing devices can include an ASIC or programmable logic array such as a field-programmable gate array (FPGA) configured as a special-purpose processor to perform one or more of the operations or operations described or claimed herein. An example FPGA can include a collection of logic blocks and random access memory (RAM) blocks that can be individually configured and/or configurably interconnected in order to cause the FPGA to perform certain functions. Certain FPGA's may contain other general or special purpose blocks as well. An example FPGA can be programmed based on a hardware definition language (HDL) design, such as VHSIC Hardware Description Language or Verilog.

The embodiments herein may be described in terms of functional block components and various processing operations. Such functional blocks may be realized by any number of hardware and/or software components that perform the specified functions. For example, the described embodiments may employ various integrated circuit components, e.g., memory elements, processing elements, logic elements, look-up tables, and the like, which may carry out a variety of functions under the control of one or more microprocessors or other control devices. Similarly, where the elements of the described embodiments are implemented using software programming or software elements the invention may be implemented with any programming or scripting language such as C, C++, Java, assembler, or the like, with the various algorithms being implemented with any combination of data structures, objects, processes, routines or other programming elements. Functional aspects may be implemented in algorithms that execute on one or more processors. Furthermore, the embodiments of the invention could employ any number of conventional techniques for electronics configuration, signal processing and/or control, data processing and the like. The words “mechanism” and “element” are used broadly and are not limited to mechanical or physical embodiments, but can include software routines in conjunction with processors, etc.

Implementations or portions of implementations of the above disclosure can take the form of a computer program product accessible from, for example, a computer-usable or computer-readable medium. A computer-usable or computer-readable medium can be any device that can, for example, tangibly contain, store, communicate, or transport a program or data structure for use by or in connection with any processor. The medium can be, for example, an electronic, magnetic, optical, electromagnetic, or a semiconductor device. Other suitable mediums are also available. Such computer-usable or computer-readable media can be referred to as non-transitory memory or media, and may include RAM or other volatile memory or storage devices that may change over time. A memory of an apparatus described herein, unless otherwise specified, does not have to be physically contained by the apparatus, but is one that can be accessed remotely by the apparatus, and does not have to be contiguous with other memory that might be physically contained by the apparatus.

The word “example” is used herein to mean serving as an example, instance, or illustration. Any aspect or design described herein as “example” is not necessarily to be construed as preferred or advantageous over other aspects or designs. Rather, use of the word “example” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. In other words, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” throughout is not intended to mean the same embodiment or implementation unless described as such.

The particular implementations shown and described herein are illustrative examples of the invention and are not intended to otherwise limit the scope of the invention in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent example functional relationships and/or physical or logical couplings between the various elements. Many alternative or additional functional relationships, physical connections or logical connections may be present in a practical device. Moreover, no item or component is essential to the practice of the invention unless the element is specifically described as “essential” or “critical”.

The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The use of the terms “a” and “an” and “the” and similar referents in the context of describing the invention (especially in the context of the following claims) should be construed to cover both the singular and the plural. Furthermore, recitation of ranges of values herein are merely intended to serve as a shorthand method of referring individually to each separate value falling within the range, unless otherwise indicated herein, and each separate value is incorporated into the specification as if it were individually recited herein. Finally, the operations of all methods described herein are performable in any suitable order unless otherwise indicated herein or otherwise clearly contradicted by context. The use of any and all examples, or example language (e.g., “such as”) provided herein, is intended merely to better illuminate the invention and does not pose a limitation on the scope of the invention unless otherwise claimed.

All references, including publications, patent applications, and patents, cited herein are hereby incorporated by reference to the same extent as if each reference were individually and specifically indicated as incorporated by reference and were set forth in its entirety herein.

The above-described embodiments have been described in order to allow easy understanding of the present invention and do not limit the present invention. To the contrary, the invention is intended to cover various modifications and equivalent arrangements included within the scope of the appended claims, which scope is to be accorded the broadest interpretation so as to encompass all such modifications and equivalent structure as is permitted under the law.

What is claimed is:

1. A system configured to provide a user interface of a visual workflow, the system comprising:
a processor;
a display operably coupled to the processor; and
a memory operably coupled to the processor, the memory storing instructions that, when executed by the processor, cause the processor to:
cause a first plurality of cells to be rendered on the display in a generally horizontal manner, each of the first plurality of cells comprising a respective workflow activity, the first plurality of cells being coupled to one another to define a first workflow; and
cause a second plurality of cells to be rendered on the display in a generally horizontal manner, each of the second plurality of cells comprising a respective workflow activity, the second plurality of cells being coupled to one another to define a second workflow related to the first workflow, wherein the first plurality of cells is not coupled to the second plurality of cells.

2. The system of claim 1, wherein a first cell of the first plurality of cells comprises at least one of the following:
a begin block having no input and a single output, wherein a second cell of the first plurality of cells comprises a selectable block having a begin input, a begin output and an indicia that permits a user to select parameters associated with the workflow activity of the second cell, and wherein a third cell of the first plurality of cells comprises a conditional block having a conditional input, a first output associated with a true condition and a second output associated with a false condition;
an iterator block having a start input and a continue input, wherein a first iteration enters the start input and wherein subsequent iterations enter the continue input;
an event triggering block having a triggering input and no output, the event triggering block being configured to cause the second workflow to begin; or
a listening block having no input and a single output, the listening block being configured to begin the second workflow in response to the triggering input being received by the event triggering block, wherein a second cell of the second plurality of cells comprises a script block having a script input and a script output, wherein the script block runs a script, and wherein a third cell of the second plurality of cells comprises a conditional block having a conditional input, a first output associated with a true condition, and a second output associated with a false condition.

3. The system of claim 1, wherein each of the first plurality of cells comprising the respective workflow activity comprises a visual indication corresponding to the respective workflow activity, such that the first workflow is interpretable by an operator of the display.

4. The system of claim 1, wherein the respective workflow activity comprises an operation that is dependent upon the processor receiving a remote input from a client device disposed separate from the display.

5. The system of claim 1, wherein the respective workflow activity comprises pausing execution of the first or second workflow until a specific time and date, pausing execution of the first or second workflow for a specified duration, creating one or more individual approval records, creating a group approval record, canceling outstanding approvals for a record, creating a database record, adding a task record, sending an email, logging workflow activity, or adding an event to a queue, or any combination thereof.

6. The system of claim 1, wherein the first workflow is configured to organize information transmitted between client devices of an enterprise by storing variables within one or more cells of the first plurality of cells, and wherein the variables stored within the one or more cells correspond to the information transmitted by at least one of the client devices of the enterprise.

7. The system of claim 1, wherein the first plurality of cells is not depicted as coupled to the second plurality of cells.

8. The system of claim 7, wherein the generally horizontal manner is configured as a horizontal lane.

9. A method of providing a user interface of a visual workflow on an electronic display, the method comprising:
displaying a first plurality of cells on the display in a generally horizontal manner, each of the first plurality of cells comprising a respective workflow activity, the first plurality of cells being coupled to one another to define a first workflow;
displaying a second plurality of cells on the display in a generally horizontal manner, each of the second plurality of cells comprising a respective workflow activity, the second plurality of cells being coupled to one another to define a second workflow, wherein the first plurality of cells is not coupled to the second plurality of cells by any lines;
receiving a selection of a subset of the first plurality of cells in the first workflow, wherein the subset of the first plurality of cells comprises fewer cells than the first plurality of cells;
duplicating the selected subset of the first plurality of cells into a new workflow;
replacing the selected subset of the first plurality of cells with a single new cell; and
mapping one or more input variables and one or more output variables from the selected subset of the first plurality of cells to one or more inputs and one or more outputs of the single new cell.

10. The method of claim 9, comprising copying values of the selected subset of the first plurality of cells into the new workflow.

11. The method of claim 9, wherein the mapping of the one or more input variables and one or more output variables from the selected subset of the first plurality of cells comprises setting the one or more inputs of the single new cell to reference a same data source of the first plurality of cells.

12. The method of claim 9, comprising displaying a third plurality of cells on the display in a generally horizontal manner, each of the third plurality of cells comprising a respective workflow activity, the third plurality of cells being coupled to one another to define a third workflow.

13. The method of claim 9, wherein the respective workflow activity comprises pausing execution of the first or second workflow until a specific time and date, pausing execution of the first or second workflow for a specified duration, creating one or more individual approval records, creating a group approval record, cancelling outstanding approvals for a record, creating a database record, adding a task record, sending an email, logging workflow activity, or adding an event to a queue, or any combination thereof.

14. The method of claim 9, comprising:
in response to receiving an indication that a first activity has changed state, render a third workflow; and
simultaneously replace the first workflow with the third workflow on the display after the third workflow is rendered, wherein the third workflow is configured to indicate that the first activity originally represented via the first workflow has progressed at least one step.

15. A system configured to provide a user interface of a visual workflow, the system comprising:
a processor; and
a memory operably coupled to the processor, the memory storing instructions that, when executed by the processor, cause the processor to:
cause a first plurality of cells to be rendered on a display in a generally horizontal manner, each of the first plurality of cells comprising a respective of a plurality of workflow activities, the first plurality of cells being coupled to one another by solid lines to define a first workflow; and
cause a second plurality of cells to be rendered on the display in a generally horizontal manner, each of the second plurality of cells comprising a respective of the plurality of workflow activities, the second plurality of cells being coupled to one another by solid lines to define a second workflow, wherein the first plurality of cells is not coupled to the second plurality of cells by any lines.

16. The system of claim 15, wherein the memory stores instructions that, when executed by the processor, cause the processor to:
receive a selection of a subset of the plurality of workflow activities in the first workflow or the second workflow; and
duplicate the subset of the plurality of workflow activities into a new workflow.

17. The system of claim 16, wherein the new workflow is configured to be stored and referenced as a sub-flow, and wherein the sub-flow is usable as one of the plurality of workflow activities after storage.

18. The system of claim 16, wherein the selection of the subset of the plurality of workflow activities occurs in a same graphical user interface rendering the first plurality of cells.

19. The system of claim 18, wherein a dialog is generated in response to the selection of the subset of the plurality of workflow activities and configured to receive a name parameter input to be assigned to the new workflow, and wherein a single cell is rendered such that the single cell visually replaces the subset of the plurality of workflow activities rendered as part of the first workflow in response to the name parameter input being received via the dialog.

20. The system of claim 15, wherein the solid lines couple a first respective workflow activity of the plurality of workflow activities and a second respective workflow activity of the plurality of workflow activities at least in part by visually coupling a bottom corner of a first respective cell to an upper corner of a second respective cell, and wherein the first plurality of cells or the second plurality of cells comprises the first respective cell and the second respective cell.
